(19) United States
(12) Patent Application Publication
(10) Pub. No.: US 2012/0105481 A1
(43) Pub. Date: May 3, 2012

(54) TOUCH CONTROL METHOD AND PORTABLE TERMINAL SUPPORTING THE SAME

(75) Inventors: Sung Hwan BAEK, Seoul (KR); Do Hee CHUNG, Seoul (KR)

(73) Assignee: SAMSUNG ELECTRONICS CO. LTD., Suwon-si (KR)

(21) Appl. No.: 13/281,944

(22) Filed: Oct. 26, 2011

Related U.S. Application Data
(60) Provisional application No. 61/409,669, filed on Nov. 3, 2010.

(30) Foreign Application Priority Data
Aug. 29, 2011 (KR) 10-2011-0084177

(51) Int. Cl. G06F 3/041; G09G 5/00

(52) U.S. Cl. 345/652; 345/173

(57) ABSTRACT

A portable terminal and method capable of detecting a touch event unintended by a user to control unnecessary touch so that a corresponding touch event is not applied are provided. The touch control method includes collecting at least one touch event of a touch panel, determining location information of the at least one collected touch event, and applying a touch event by disregarding the collected touch event when the location information is an invalid region.

### PRIORITY

This application claims the benefit under 35 U.S.C. §119(e) of a U.S. Provisional patent application filed on Nov. 3, 2010 in the U.S. Patent and Trademark Office and assigned Ser. No. 61/409,669, the entire disclosure of which is hereby incorporated by reference.

### BACKGROUND OF THE INVENTION

1. Field of the Invention

The present invention relates to a touch function. More particularly, the present invention relates to a touch control method capable of determining a touch event unintended by a user to restrain unnecessary touch control so that a corresponding touch event is not applied, and a portable terminal supporting the same.

2. Description of the Related Art

A portable terminal supports a call function based on mobility and has been used in various fields due to convenience and easy portability. The portable terminal has provided various input schemes for user functions. For example, a portable terminal according to the related art may provide a touch screen with a touch panel and a display unit that allows a user to process an operation performed and to select a certain image output on the display unit. Further, the portable terminal creates a touch event according to a corresponding user operation, and controls an application program corresponding to a user function based thereon. The portable terminal simultaneously drives the touch panel and the display unit, performs a certain operation according to an occurrence location and a type of touch event occurring on the touch panel, and controls the display unit to output a corresponding image.

While gripping the portable terminal, the user generates input signals for operating various services. For example, a user's hand may grip at least one of a rear side and a lateral side of a terminal case, and perform a touch operation on a touch panel by using the other hand to perform a controlling operation so that a desired function is activated. However, a partial region of the portable terminal may be unnecessarily touched by the hand gripping the terminal. Accordingly, a user would have to carefully grip a region on which the touch panel is not disposed when gripping the portable terminal. When the user erroneously touches the touch panel, the user is inconvenienced in that an execution of an unintended function of the terminal may occur.

Recently, such inconvenience occurs more frequently in portable products having an enlarged display unit in comparison with that of a portable terminal previously manufactured and purchased. That is, due to the increased size of portable products, it is difficult for a user to support the product by gripping only a rear side of a terminal case with one hand, such that the user is forced to grip a lateral side of the terminal with the other hand. In this case, to equalize the weight of the terminal, a finger arranged at a front surface of the terminal would have to be sufficiently moved and fixed to a center part of the terminal. In other words, a gripping form in which a finger of the user and a part of the finger surrounding a part of a touch panel is provided. At this time, the terminal recognizes a touch caused by the corresponding grip as a touch input operation and performs a corresponding operation. Substantially, because the touch input operation caused by the grip is not intended for a certain function, the grip causes an unintended touch event by the user. As a result, the user is inconvenienced by the necessity of cancelling the unintended touch event and then creating an intended touch event. Accordingly, it is very difficult for a user to grip a limited area of an outer zone of the terminal in order to avoid contact with the touch panel where a continuous gripping operation is required. In addition, such a gripping operation is a burden to a user's hand or wrist.

### SUMMARY OF THE INVENTION

Aspects of the present invention are to address at least the above-mentioned problems and/or disadvantages and to provide at least the advantages described below. Accordingly, an aspect of the present invention is to provide a touch control method that suitably recognizes occurrence of a touch event unintended by a user and processes the touch event according thereto to efficiently and stably control a touch operation of a portable terminal and to stably grip the portable terminal, and a portable terminal supporting the same.

In accordance with an aspect of the present invention, a touch control method is provided. The method includes collecting at least one touch event of a touch panel, determining location information of the at least one collected touch event, and applying a touch event by disregarding the collected touch event when the location information is an invalid region.

In accordance with another aspect of the present invention, a portable terminal support touch control is provided. The terminal includes a touch panel for collecting at least one touch event, and a controller for determining location information of the at least one collected touch event, and for performing a controlling operation so that the collected touch event is disregarded when the location information of the at least one collected touch event is an invalid region.

A touch control method and a portable terminal supporting the same according to an exemplary embodiment of the present invention may control the occurrence of an unnecessary touch and accordingly, a user function may be easily used.

Further, an exemplary embodiment of the present invention provides a stable grip form of the portable terminal such that a user may stably use the portable terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a portable terminal supporting touch control according to an exemplary embodiment of the present invention;

FIG. 2 is a block diagram illustrating a controller according to an exemplary embodiment of the present invention;

FIG. 3 is a flowchart illustrating a touch control method according to an exemplary embodiment of the present invention;

FIG. 4 is a view illustrating a touch control method according to an exemplary embodiment of the present invention;

FIG. 5 is a view illustrating a touch control method according to an exemplary embodiment of the present invention;

FIG. 6 is a view illustrating a touch control method according to an exemplary embodiment of the present invention;

FIG. 7 is a view illustrating a touch control operation according to an exemplary embodiment of the present invention; and

FIG. 8 is a view illustrating a touch control operation according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

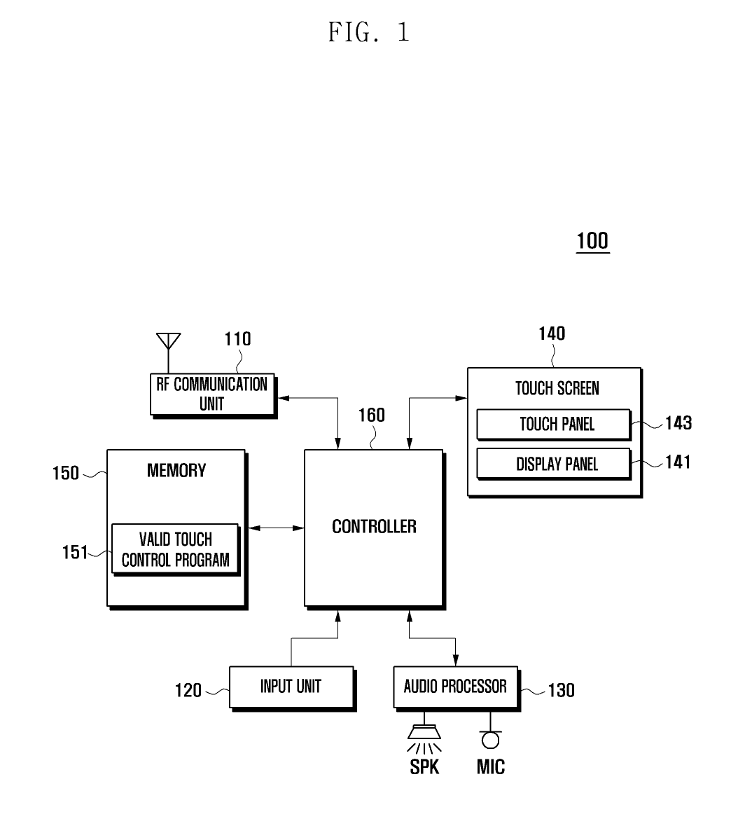

FIG. 1 is a block diagram illustrating a configuration of a portable terminal supporting touch control according to an exemplary embodiment of the present invention.

Referring to FIG. 1, the portable terminal 100 may include a Radio Frequency (RF) communication unit 110, an input unit 120, an audio processor 130, a touch screen 140, a memory 150, and a controller 160.

The portable terminal 100 having a construction as described above processes a preset region of a touch panel 143 as an invalid region while a display panel 141 is operated in an active state according to a certain user function mode or an active state of a certain application program. Accordingly, when a user selects a certain user function mode or activates a certain application program, the portable terminal 100 invalidates a touch event occurring at a certain region of the touch panel 143 and processes a touch event occurring at a region set as a valid region according to preset information. Accordingly, when a user touches a certain region to grip the portable terminal 100, the portable terminal 100 may normally operate a function operation according to a touch event occurring at a valid region. Functions and roles of respective structural elements for processing a touch event according to an exemplary embodiment of the present invention will be described below.

The RF communication unit 110 forms a communication channel for a speech call, a communication channel for an image call, and a communication channel for transmitting data such as images or messages under the control of the controller. That is, the RF communication unit 110 forms a speech call channel, a data communication channel, and an image call channel between mobile communication systems. The RF communication unit 110 may include an RF transmitter up-converting a frequency of a transmitted signal and amplifying the signal, and an RF receiver low-noise-amplifying a received signal and down-converting the signal. A user function based on the RF communication unit 110 may be selected and activated according to a touch event created from a touch panel 143 or an input signal generated from the input unit 120.

Meanwhile, while a communication function is operated based on the RF communication unit 110, the touch panel 143 may set a preset region as an invalid region. For example, the touch panel 143 may set regions, except for a key map region, to which a key map provided for operation of the RF communication unit 110 is output and an output region to which characters selected due to generation of a touch event on the key map are output as an invalid region. Accordingly, a user may perform a touch operation to stably and firmly operate the RF communication unit 110 while gripping a case of the portable terminal 100 including a touch panel 143 of a region, except for the key map region and the output region. In this case, the key map region may be defined as a region composed of key map objects and the output region may be defined as an object defining a channel output space. The controller 160 may define a touch panel 143 region corresponding to a region to which the foregoing object is output as a valid region and define a touch panel 143 region corresponding to a region except for the object as an invalid region.

The input unit 120 may create a first input signal for setting a valid touch region and a second input signal for setting an invalid touch region. The first and second created input signals may be transferred to the controller 160 and used as a command for supporting an invalid touch function. The input unit 140 may receive input of numerals or text information and includes a plurality of input keys and functions keys for setting all types of functions. The function keys may include arrow keys, side keys and hot keys set to execute specific functions. Further, the input unit 120 generates a key signal associated with a user setting and function control of a portable terminal 100, and provides the generated key signal to the control unit 160. The input unit 120 may be implemented by a Qwerty key pad, a 3*4 key pad, or a 4*3 key pad. Further, the input unit 120 may be implemented by a Qwerty key map, a 3*4 key map, a 4*3 key map, or a control key map. In the meantime, when a touch screen 140 of the portable terminal 100 is supported in a full touch screen form, the input unit 120 may include only a side key provided at one side of a case of the portable terminal 100.

The audio processor 130 includes a Speaker (SPK) for playing transmitted and received audio data at a call time, audio data included in a received message, and audio data according to playback of audio files stored in the memory 150. The audio processor 130 also includes a Microphone (MIC) for collecting a user's voice or other audio signals at the call time. When a touch operation occurs on a touch panel 143 of the portable terminal 100 to create a corresponding specific touch event, the audio processor 130 may output a sound effect according to the touch event. An output of the sound effect according to the touch event may be removed according to a user setting. Further, when another touch event occurs together with a touch event to be invalidated, the audio processor 130 may output a corresponding sound effect. Such a sound effect may be output as a sound distinguished from generation of a general touch event. The output of the effect sound according to the touch event may be removed according to a user setting.

The touch screen includes a display panel 141 and a touch panel 143. The touch screen 140 may have a structure in which the touch panel 143 is disposed at a front surface of the display panel 141. The size of the touch screen 140 may be determined depending on the size of the touch panel 143. Accordingly, the portable terminal 100 may include a structure in which the size of the touch panel 143 is larger than the size of the display panel 141. For example, when the display panel 141 is disposed to occupy a part of an entire surface of the portable terminal 100, the display panel 143 may be disposed on an entire surface of the portable terminal 100 to occupy a region of the display panel 141. Accordingly, a region in which a display panel 141 displaying images is disposed and a region of a touch panel 143 may be allotted to the portable terminal 100. A touch event occurring in the region of the touch panel 143 may be processed as a normal touch event according to certain situations. A touch event occurring in a region of a corresponding touch panel may be invalidated.

The display panel 141 displays all types of menus of the portable terminal 100, information input by a user, or information provided to the user. That is, the display panel 141 may provide various screens according to use of the portable terminal 100, for example, an idle screen, a menu screen, a message creation screen, and a call screen. The display panel 141 can be configured by a flat panel display such as a Liquid Crystal Display (LCD) or an Organic Light Emitted Diode (OLED). Further, the display panel 141 may be provided at an upper portion or a lower portion of the touch panel 143. More particularly, the display panel 141 according to an exemplary embodiment of the present invention may output various screens for supporting a corresponding application program according to an activated application program. In this case, the display panel 141 may output various objects, a frame composed of various objects, a page composed of a plurality of frames, and a layer composed of a plurality of pages on a screen according to a design of a corresponding application program. In this case, an invalid region of the touch panel 143 may be set differently according to respective constructions output on the display panel 141.

The touch panel 143 is disposed in at least one of an upper portion or a lower portion of the display panel 141. The touch panel 143 may generate a touch event according to contact or an approach distance of an object and transfer the generated touch event to the controller 160. In this case, a sensor constituting the touch panel is arranged in a matrix pattern. Corresponding location information on the touch panel 143 and information regarding a type of touch event are transferred to the controller 160 according to the touch event occurring on the touch panel 143. The controller 160 determines location information and the type of touch event transferred from the touch panel 143. The control unit 160 may determine specific information of the display unit 141 mapped to a corresponding location and then activate a user function linked to the corresponding specific information. As described above, the touch panel 143 may be manufactured larger than the size of the display panel 141 and disposed at a front surface of a case of the portable terminal 100. Accordingly, at least a partial region of the touch panel 143 may be disposed at a region in which the display panel 141 is not disposed. A corresponding region of the touch panel 143 may generate a touch event due to a touch operation according to a type of function supported from the portable terminal 100 and transfer the touch event to the controller 160.

More particularly, while an application program provided from the portable terminal 100 is activated, a preset region of the touch panel 143 may be divided into a valid touch event region and an invalid touch event region. In this case, the application program may become an idle screen support program, a file playback program, a file search program, or a program corresponding to various user functions supported from the portable terminal 100. A region set as an invalid region among regions of the touch panel 143 may be disregarded by the controller 160 although a touch event occurs therein. In the meantime, a valid region and an invalid region of the touch panel 143 may be defined by screen elements output on the display panel 141. That is, when a frame with a plurality of objects is output on the display panel 141, a region of the touch panel 143 corresponding to a region on which respective objects are output may be defined as a valid region, and a region on which no objects are output may be defined as an invalid region. Further, although a plurality of objects are output, an execution priority of a touch event occurring in the touch panel 143 may be determined according to priority information of the respective objects. A user interface associated with setting the valid region and the invalid region of the touch panel 143 will be described in more detail below.

The memory 150 may store information regarding a key map, a menu map, or a touch lock part cancellation area for an operation of the touch screen 140 as well as an application program necessary for a function operation according to an exemplary embodiment of the present invention. Here, the key map or the menu map may become various forms, respectively. That is, the key map may include a keyboard map, a 3*4 key map, a Qwerty key map, or a control key map for controlling an operation of a currently activated application program. In the meantime, the menu map may include a menu map for controlling an operation of the currently activated application program. The memory 150 may include a program area and a data area.

The program area may store an Operating System (OS) for booting the portable terminal 100 and for operations of respective constructions, and application programs for playing various files such as an application program for supporting a call function of the portable terminal 100, a web browser accessing an Internet server, an MP3 application program playing other sound sources, an image output application program playing photographs, and a moving image playing application program. More particularly, the program area may store a valid touch control program 151.

The valid touch control program 151 may include a routine supporting selection of an invalid region setting mode, a definition routine defining a preset region as a valid region and an invalid region while a function screen is being output on the display panel 143, and a routine processing respective touch events occurring at the valid region and the invalid region according to characteristics of a corresponding region.

The definition routine may include an object based definition routine setting a valid region and an invalid region based on objects in a frame composed of at least one object output on the display panel 141, a frame based definition routine setting a valid region and an invalid region based on priority information of a plurality of frames in a page composed of the plurality of frames, and a page based definition routine setting valid regions and invalid regions of respective layers based on priority information of respective pages in layers composed of a plurality of pages. The priority information of the definition routines may be changed according to a context through a user definition or a designer definition. The definition routine may further include a default routine defining a preset region, for example, an edge region of a touch panel 143 of the portable terminal 100 as the invalid region according to a type of activated application program.

The data area stores data created according to use of the portable terminal 100, and may store phone book data, at least one icon according to a widget function, and various contents. Further, the data area may store user input from the touch panel 143. More particularly, the data area may store area setting information defining a valid region and an invalid region of the touch panel 143. Further, the data area may store region setting information by functions defining valid regions and invalid regions by programs. When an invalid region setting mode is activated, the region setting information and the regions setting information by functions may be referred by the controller 160 and referred to support an invalid region setting function of the touch panel 143. Meanwhile, the region setting information by functions may include a user function list of at least one function of a memo function, a message making function, an electronic mail making function, a file edit function, or a touch pen based user function.

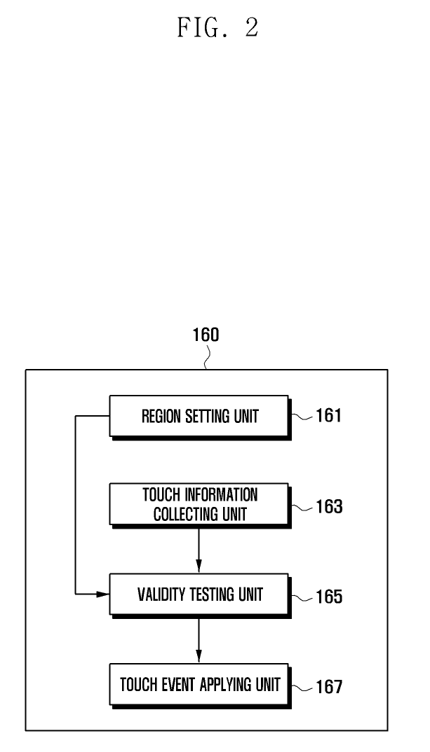

The controller 160 controls power supplied to respective structural elements of the portable terminal 100 to execute an initializing procedure. The controller 160 may control setting the valid region and the invalid region of the touch panel 143 by referring to at least one of the region setting information and the region setting information by functions stored in the memory 150. To do this, the controller 160 may include structural elements as illustrated in FIG. 2.

FIG. 2 is a block diagram illustrating a controller according to an exemplary embodiment of the present invention.

Referring to FIG. 2, the controller 160 may include a region setting unit 161, a touch information collecting unit 163, a validity testing unit 165, and a touch event applying unit 167. The region setting unit 161 performs a controlling operation so that a valid region and an invalid region are set according to a used state. The region setting unit 161 may call the region setting information and the region setting information by functions stored in the memory 150, and set a preset region and another region of the touch panel 143 as an invalid region and a valid region, respectively. For example, the region setting unit 161 may define a region of the touch panel 143 corresponding to objects output on the display panel 141 based on an object based definition routine and a region of the touch panel 143 corresponding to a region other than the objects as the valid region and the invalid region, respectively. When the region setting unit 161 refers to a frame based definition routine, it may set a region of the touch panel 143 corresponding to a specific frame among a plurality of frames output on the display panel 141 and a region of the touch panel 143 corresponding to another frame as the valid region and the invalid region, respectively. In a case where the region setting unit 161 refers to a page based definition routine, when a plurality of pages are output on the display panel 141 to distinguish a layer, it may set a region of the touch panel 143 corresponding to a specific page among corresponding pages and a region of the touch panel 143 corresponding to another page as the valid region and the invalid region, respectively. Further, the region setting unit 161 may set a preset edge region of the touch panel 143 as the invalid region while an idle screen, a menu screen, or a widget screen is being output through a default routine.

The touch information collecting unit 163 collects a touch event according to a touch operation on the touch panel 143, generation location information of the touch event, and moving information of the touch event. The touch information collecting unit 163 may transfer the collected information to the validity testing unit 165.

The validity testing unit 165 collects the valid region information and the invalid region information set by the region setting unit 161 and tests validity of the touch event provided from the touch information collecting unit 163. That is, if the touch information collecting unit 163 transfers touch event relation information, the validity testing unit 165 determines location information of a touch event and determines whether a corresponding location is a location set as the valid region or the invalid region. When the transferred touch event is a touch event occurring at a location set as the invalid region, the validity testing unit 165 performs a controlling operation so that a corresponding touch event is disregarded. When the touch event is transferred to the touch event applying unit 167, the validity testing unit 165 may transmit information indicating that the touch event is a touch event located at a valid region upon transmission of the corresponding touch event together therewith. That is, the validity testing unit 165 may control the touch event provided from the touch information testing unit 163 to not be transferred to the touch event applying unit 167 according to certain situations. In the meantime, when a location of a touch event is a location defined as a valid region, the validity testing unit 165 may transfer a corresponding touch event to the touch event applying unit 167. In a case where there is a plurality of touch events occurring in the valid region, if there is priority information of corresponding touch events, the validity testing unit 165 determines the priority information. When a corresponding touch event is transferred to the touch event applying unit 167, the validity testing unit 165 may transfer the priority information together therewith.

The touch event applying unit 167 may receive information associated with a location of the touch event provided from the validity testing unit 165, and processing of the touch event based on the information associated with the location of the touch event. That is, the touch event applying unit 167 determines whether the received touch event has location information of the valid region or location information of the invalid region. The touch event applying unit 167 may perform a controlling operation so that a touch event having the location information of the invalid region is disregarded and a touch event having the location information of the valid region is processed. When a touch event having the location information of the valid region is processed, the touch event applying unit 167 may determine priority information about a corresponding valid region, determine a processing order of touch events or control a combination between the touch events according to the priority information. A description thereof will be given in more detail below.

As described above, the portable terminal 100 according to an exemplary embodiment of the present invention divides a region of the touch panel 143 into a valid region and an invalid region according to various definitions to process a touch event occurring in a region by the user, thereby providing convenience of use due to generation of an unintended touch event.

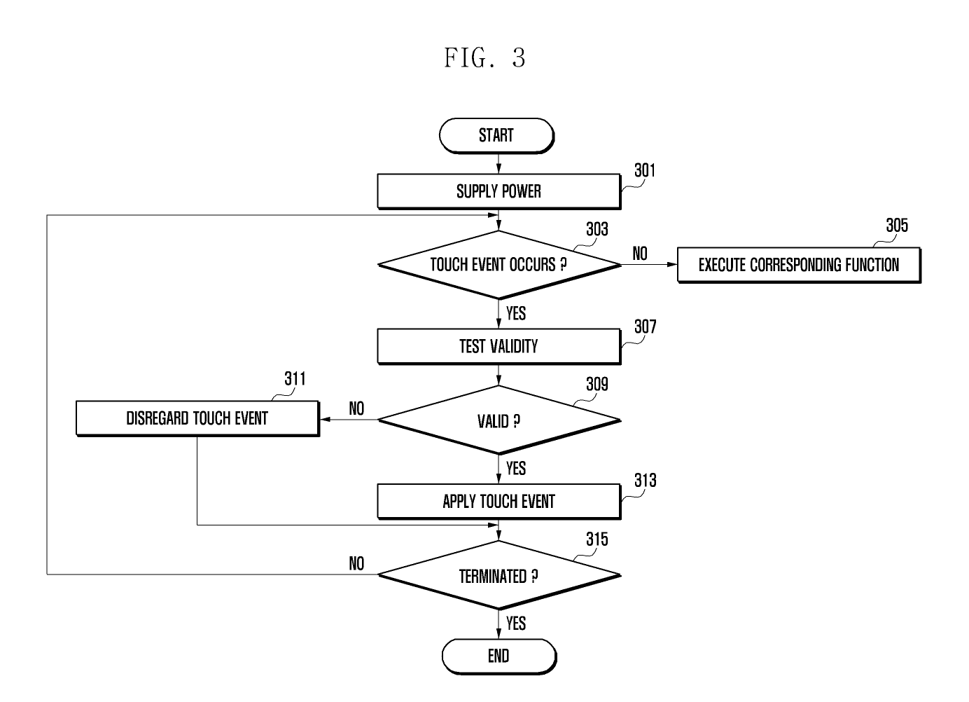

FIG. 3 is a flowchart illustrating a touch control method in a portable terminal according to an exemplary embodiment of the present invention.

Referring to FIG. 3, a controller 160 of the portable terminal 100 may perform a controlling operation so that power provided from a power supply unit such as a battery is supplied to respective structural elements of the portable terminal 100 at step 301. In this case, the controller 160 performs a controlling operation so that power is supplied to a touch panel 143 and a display panel 141 in a power supply procedure to support a touch invalid function. More particularly, the controller 169 may set a preset region and another region of the touch panel 143 as an invalid region and a valid region, respectively. To do this, the controller 160 may refer to region setting information or region setting information by functions stored in the memory 150. The region setting information includes information defining the valid region and the invalid region of the touch panel 143. The region setting information may include information defining a valid region and an invalid region based on an object, information defining a valid region and an invalid region based on a frame, information defining a valid region and an invalid region based on a page, and information defining an optional region as the invalid region. The region setting information by functions is information defining the preset region as the invalid region upon activation of a certain application program. The region setting information by functions may contain information defining identical or different invalid regions for plural registered application programs.

Next, the controller 160 may determine whether a touch event occurs from a touch screen 140 at step 303. When the touch event is not generated and an input signal is generated from an input unit 120, the controller 160 may perform a controlling operation so that a user function is executed according to a corresponding input signal at step 305.

Conversely, when the touch event occurs at step 303, the controller 160 may test validity of the touch event at step 307. To do this, the controller 160 may determine whether location information of the touch event is included in location information of an invalid region by comparing location information of a touch panel 143 set as the invalid region with the location information of the touch event.

When the touch event is invalid at step 309, the controller 160 may perform a controlling operation so that the touch event is disregarded at step 311. Conversely, when the generated touch event is valid at step 309, the controller 160 may perform a controlling operation so that the touch event is applied at step 313. That is, the controller 160 may use a valid touch event as an input signal applied to a currently activated application program.

Subsequently, the controller 160 determines whether an input signal for terminating the portable terminal 100 is generated at step 315. When the input signal for terminating the portable terminal 100 is not generated, the process may return to step 303 and repeat the foregoing procedures.

As described above, the portable terminal 100 according to an exemplary embodiment of the present invention may set and support an invalid region for invalidity of a touch event occurring in a preset region of the touch panel 143. The user may stably grip the portable terminal 100 based on the invalid region, and prevent damage caused by an inconvenient grip of the portable terminal 100.

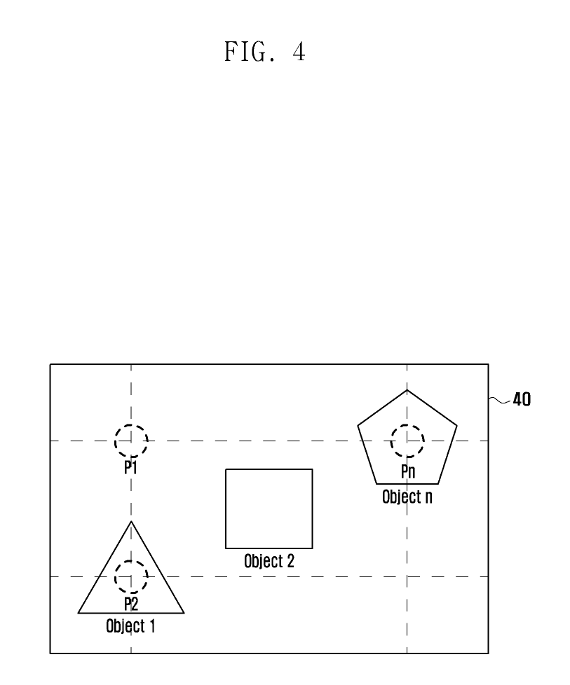

FIG. 4 is a view illustrating a touch control method according to an exemplary embodiment of the present invention.

Referring to FIG. 4, a frame 40 may be composed of a plurality of objects such as Object 1, Object 2, and Object n. The frame 40 may be output on a display panel 141, and Object 1, Object 2, and Object n may be disposed as screen elements of the display panel 141. The user may perform a P1 touch operation and then perform a Pn touch operation. That is, the user may perform the P1 touch operation in a frame 40 and then perform the Pn touch operation or perform the Pn touch operation together with the P1 touch operation. In this case, the P1 touch operation may become an optional touch operation performed on a region to which Object 1, Object 2, and Object n are not output, and the Pn touch operation may become an optional touch operation performed on a region to which Object n is output. If the foregoing touch operations are performed, a touch information collecting unit 163 of the controller 160 may collect a touch event according to the P1 touch operation and a touch event according to the Pn touch operation, and transfer the collected touch events to the validity testing unit 165.

Accordingly, the validity testing unit 165 may recognize a region in which a P1 touch operation defined according to an object based definition routine occurs as the invalid region. Further, the validity testing unit 165 may recognize a region in which a Pn touch operation defined according to a corresponding definition routine occurs as the valid region. As a result, the touch event applying unit 167 may perform a controlling operation so that a separate operation, according to a touch event caused by the P1 touch operation, is not performed and a touch event, according to a Pn touch operation, is applied to a corresponding function. For example, when the Object n is an icon associated with a certain user function, the touch event applying unit 167 may perform a controlling operation so that a corresponding user function is activated according to a touch event caused by a Pn touch operation.

In the meantime, when a P2 touch operation and a Pn touch operation occur, the touch information collecting unit 163 may collect and transfer touch events according to the respective touch operations to the validity testing unit 165. The validity testing unit 165 may recognize both the P2 touch operation and the Pn touch operation as a touch operation occurring on a valid region based on region setting information defined according to a definition routine. Accordingly, the validity testing unit 165 collects priority information of Object 1 of a touch event occurring by a P2 touch operation and priority information of Object n of a touch event occurring by a Pn touch operation. The priority information may be defined by frames 40 and controlled by a user or a designer.

If the touch event applying unit 167 receives the touch event and the priority information from the validity testing unit 165, it may perform a controlling operation so that the touch event is applied according to the priority information. For example, when a Pn touch event occurring on Object n has a priority higher than that of a P2 touch event occurring on Object 1, the touch event applying unit 167 may perform a controlling operation so that the P2 touch event is disregarded and only the Pn touch event is applied. When the P2 touch event has a priority higher than that of the Pn touch event, the touch event applying unit 167 may perform a controlling operation so that the Pn touch event is disregarded and only the P2 touch event is applied. Meanwhile, when the P2 touch event and the Pn touch event have the same priority, the touch event applying unit 167 may apply both the P2 and Pn touch events so that a function such as a multi-touch may be executed. When the P1 touch event is received but the Pn touch event is determined while receiving the Pn touch event, the touch event applying unit 167 may perform a controlling operation so that the P1 touch event is disregarded but a function according to the Pn touch operation is executed.

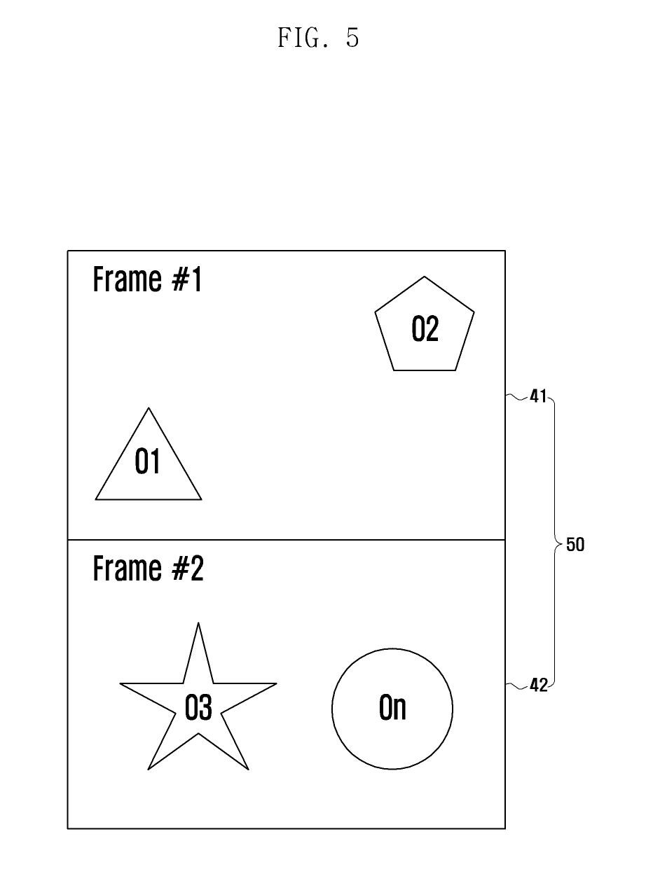

FIG. 5 is a view illustrating a touch control method according to an exemplary embodiment of the present invention.

Referring to FIG. 5, a touch control method in a page such as page 50 is composed of a plurality of frames such as frames 41 and 42. For convenience of description, it is assumed that page 50 is composed of two frames 41 and 42 that are output on a display panel 141. In the meantime, it is assumed that two objects O1 and O2 are disposed at a first frame 41, and two objects O3 and On are also disposed at a second frame 42. Page 50 having a structure as illustrated previously may have a priority for touch input by frames. The priority for touch input by frames may be controlled according to Context variation due to a user setting or a definition of a designer.

Meanwhile, if a touch event for executing an operation in the second frame 42 occurs while collecting touch events occurring in the first frame 41, the touch information collecting unit 163 collects type and location information of respective touch events. Further, the touch information collecting unit 163 may transfer the collected information of touch events to the validity testing unit 165. The validity testing unit 165 may recognize an output state of page 50 composed of frames 41 and 42 on the display panel 141, and collect priority information of respective frames 41 and 42. The foregoing information may be defined by a frame based definition routine and be referred by the controller 160 to output page 50 composed of frames 41 and 42 on the display panel 141. As a result, the validity testing unit 165 may determine priority information of the respective frames 41 and 42 by the definition routine together with output state information of page 50 on the display panel 141. The validity testing unit 164 may determine whether a touch event is valid based on the priority information.

Accordingly, when a priority of the first frame 41 is higher than the priority of a second frame 42, the touch event applying unit 167 may perform a controlling operation so that a touch event occurring in the second frame 42 is disregarded and a touch event occurring from the first frame 41 is applied to a corresponding function. Conversely, when the second frame 42 has a priority higher than the priority of the first frame 41, the touch event applying unit 167 may perform a controlling operation so that only a touch event occurring in the second touch frame 41 is applied. When the first and second frames 41 and 42 have the same priority information, the touch event applying unit 167 may recognize it as a multi-touch and control execution of a corresponding operation.

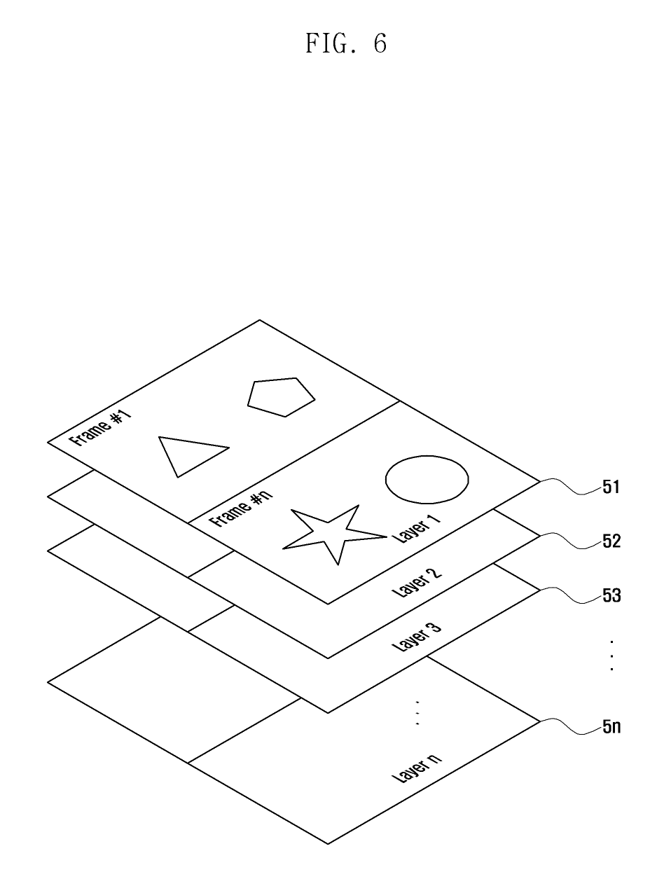

FIG. 6 is a view illustrating a touch control method according to an exemplary embodiment of the present invention.

Referring to FIG. 6, layers formed by a plurality of pages 51, 52, 53, . . . , 5n may be output on a display panel 141. The respective pages 51, 52, 53, . . . , 5n may have priorities, and each priority may be changed according to Context control. The layers formed by the respective pages 51, 52, 53, . . . , 5n are a buffer layers, and object information in an optional layer may be stored therein. The foregoing pages 51, 52, 53, . . . , 5n may overlap and be displayed on the display panel 141. In this case, at least a part of the respective pages may be exposed to the display panel such that the user selects a page disposed in the optional layer. At this time, objects disposed in a certain page may be exposed to the display panel 141. That is, the objects disposed in the certain page may be selected by the user without change in the layer. If a plurality of touch events occur, a touch information collecting unit 163 collects and transfers types and location information of the plurality of touch events to a validity testing unit 165. The validity testing unit 165 may determine respective validities of the plurality of touch events occurring during a page based definition routine. Accordingly, the touch event applying unit 167 may perform a controlling operation so that a certain touch event is applied to a corresponding function according to validity determination in the touch event by the validity testing unit 165. more particularly, the touch event applying unit 167 may perform a controlling operation so that a corresponding touch event is applied to objects of the page disposed in the certain layer according to the priorities.

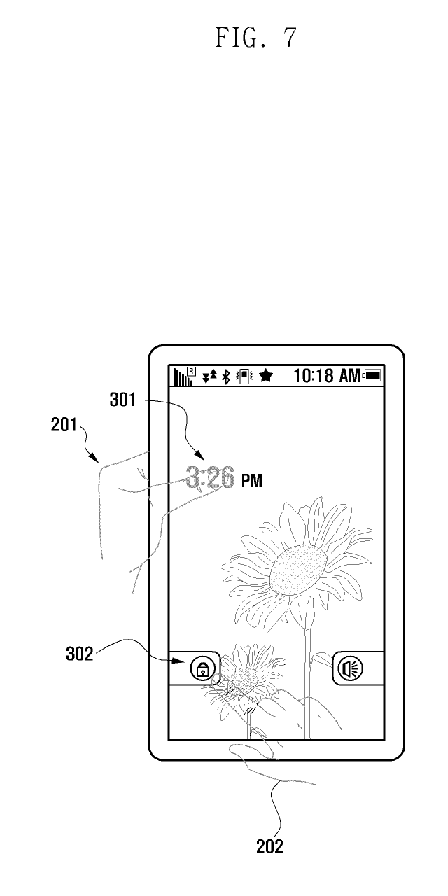

FIG. 7 is a view illustrating an operation of a portable terminal to which a touch control method is applied according to an exemplary embodiment of the present invention.

Referring to FIG. 7, a user may grip an upper left region 301 of the portable terminal 100 with a left hand as illustrated. Simultaneously, the user may perform a touch operation to control an operation of the portable terminal 100 using a right hand. In this case, the touch information collecting unit 163 may continuously collect touch-down events occurring on the upper left region 301 in which the left hand 201 is located. Further, the touch information collecting unit 163 may collect touch-down events or touch drag events occurring as the right hand 202 moves at a lower left region 302 of the touch panel 143. The touch information collecting unit 163 may transfer collected touch event information to a validity testing unit 165 together with location information thereof.

The validity testing unit 165 may determine whether a region corresponding to occurrence location information of a touch event is valid or invalid. When the validity testing unit 165 collects region setting information that the upper left region 301 is an invalid region and the lower left region 302 is a valid region, it may perform a controlling operation so that touch-down events continuously collected from the upper left region 301 are disregarded. The validity testing unit 165 may transfer only a touch-down event or a touch drag event occurring at the lower left region 302 to the touch event applying unit 167. The touch event applying unit 167 may execute a corresponding function, for example, a touch lock release function based on the touch event occurring at the lower left region 302.

As described above, the portable terminal 100 according to an exemplary embodiment of the present invention invalidates a touch event occurring at a preset region of the touch panel 143 to normally execute a function according to a touch event intended by the user. In a previous case, when a touch event occurs continuously at the upper left region 301 and a touch event occurs at the lower left region 302, a touch event of the lower left region 302 is not normally applied or a touch event unintended by the user is applied. However, only a touch event occurring at a preset region is valid based on region setting information to substantially apply a touch event intended by the user.

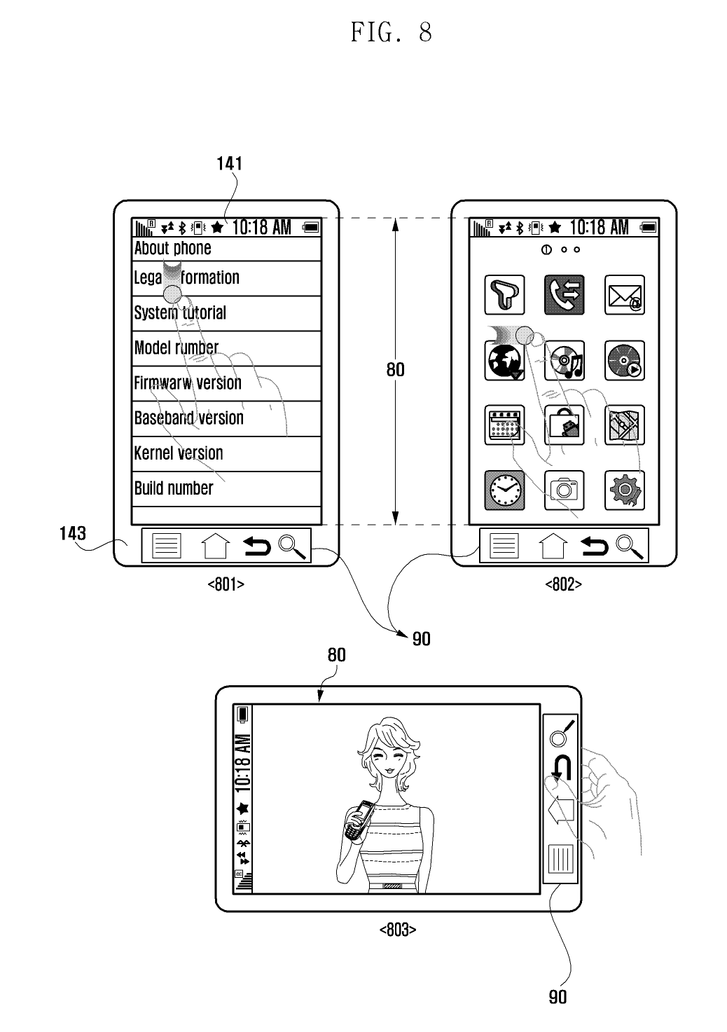

FIG. 8 is a view illustrating an operation of a portable terminal to which a touch control method is applied according to an exemplary embodiment of the present invention.

Referring to FIG. 8, the portable terminal 100 may include a touch panel 143 and a touch panel manufactured larger than the display panel 141. Accordingly, a region on which the display panel 141 and the touch panel 143 are simultaneously disposed and a region on which only the touch panel 143 is disposed may be distinguished from each other. The region on which only the touch panel 143 is disposed may function as a touch button according to definition. Hereinafter, for convenience of description, in an entire surface of the portable terminal 100, it is assumed that the region on which the display panel 141 and the touch panel 143 are simultaneously disposed is defined as an image region 80, and the region on which only the touch panel 143 is disposed is defined as a button region 90.

In a first screen 801, when objects requiring a scroll are displayed on an image region 80, a user may touch a preset area of the image region 80 and perform a scroll operation for generating a scroll touch event. To do this, the user may grip the portable terminal 100 or fix it to a preset location and then perform a touch operation on the image region 80 using a touch object, in particular, a hand. At this time, while the hand of the user is performing a touch operation on the image region, another part of the hand, for example, a lower end of the hand such as the palm may contact the button region 90. Accordingly, a controller 160 of the portable terminal 100 may collect touch events according to contact of the button region 90 to determine validity of a corresponding touch event. In this case, the controller 160 may determine region setting information by functions to determine priority information of the button region 90 upon activation of a scroll function.

At this time, when priority of the image region 80 is set to be higher than that of the button region 90, the controller 160 may perform a controlling operation so that a touch event of the button region 90 occurring simultaneously with generation of a scroll touch event is disregarded. In this case, the controller 160 may perform a controlling operation so that all touch events of the button region 90 occurring for several milliseconds just before generation of the scroll touch event and for several milliseconds directly after generation termination of the scroll touch event are invalidated. To do this, when a scroll function is supported, the controller 160 may temporarily store a touch event occurring in the button region 90 and determine whether a scroll touch event occurs within a preset time interval. Further, where a scroll function is supported, if a scroll touch event occurs, the controller 160 may perform a controlling operation so that a touch event occurring on the button region 90 within a preset time interval is disregarded.

The portable terminal 100 may output a menu screen or a widget screen on an image region from a second screen 802 having a form different from that of the first screen 801. Upon collection of scroll touch events occurring at an image region 80 similar to the first screen 801, a controller 160 of the portable terminal 100 may perform a controlling operation so that touch events in a button region 90 simultaneously or sequentially collected within a preset time interval are disregarded.

Meanwhile, as in a third screen 803, when a certain user function, for example, a moving image playback function is executed, the controller 160 of the portable terminal 100 may determine region setting information by functions. Further, the controller 160 may perform a controlling operation so that a specific region is invalidated according to region setting information by functions of the moving image playback function. For example, the controller 160 may perform a controlling operation so that a button region during playback of a moving image is defined as an invalid region and a touch event occurring on the button region 90 is invalidated. Here, although a moving playback function is illustrated as a corresponding function to set region setting information by functions, a function for applying the region setting information by functions may become another function. That is, a function applied to the third screen 803 may become a landscape mode function. Accordingly, when a mode of the portable terminal 100 is switched from a portrait mode to a landscape mode, the controller 160 may determine region setting information by functions to set a corresponding invalid touch region. To do this, the region setting information by functions may contain information defining the button region 90 as an invalid region in the landscape mode. The region setting information by functions may further contain information defining a partial left region of the image region 80 as an invalid touch region in the landscape mode.

Further, in the portable terminal 100, other user functions such as a memo making function, a message making function, an electronic mail making function, a file edit function, and the like, namely, an application program greatly requiring an outside of the terminal to be gripped may be included in region setting information by functions. When at least one of the user functions requiring the portable terminal 100 to be gripped, such as the memo making function, the message making function, the electronic mail making function, the file edit function, a touch pen based user function, and the like, is activated, the controller 160 may define a preset region of a touch panel, for example, an edge region of the touch panel as an invalid region. For example, the controller 160 may temporarily define the button region 90 of the touch panel on which no images of a display panel are output as an invalid region. Accordingly, the user may stably create memos, messages, or electronic mail on a display panel using a touch pen or a finger while stably gripping the button region 90. In this case, the button region 90 may become a region on which an unnecessary contact may occur by a user's grip.

Furthermore, the button region 90 of the present invention may be temporarily defined as an invalid region according to the user's grip. More particularly, as illustrated, when a user grips the button region 90, there is more contact with the button region 90 differently from a case of touching the button region 90. Accordingly, the controller 160 determines a touched area of the button region 90. When the touched area of the button region 90 is equal to or greater than a preset value, the controller 160 may temporarily define the button region 90 as an invalid region. The definition of the invalid region in the touch panel is not applied to only the button region 90 but is applicable to the whole touch panel. That is, if a touch event occurs, the controller 160 determines whether a touch area of a touch event in a region in which touch events are collected is equal to or greater than a preset value. When the touch area of the touch event is equal to or greater than the preset value, the controller 160 may perform a controlling operation so that a preset region of a touch panel is defined as an invalid region based on a point in which location information of a corresponding touch event is generated. When a touch event occurring at a touch area equal to or greater than the preset value is released, a preset region of a touch panel defined as an invalid region may be defined as the valid region under the control of the controller 160.

In the meantime, the controller 160 may perform a support operation according to invalidity of the button region 90 so that a touch map corresponding to a button region 90 is output on at least a partial region of the image region 80 according to preset conditions. For example, when the user performs a preset touch operation in a preset region of the image region 80, the controller 160 outputs a touch map corresponding to the button region 90 on the image region 80 according to a preset touch event occurring corresponding to a touch operation. Accordingly, the user may use a function provided from the button region 90 through control of a corresponding touch map. In the meantime, the controller 160 may allow the user to easily recognize that the button region 90 is set as an invalid touch region simultaneously with execution of validating the button region 90. For example, the controller 160 may control a Light Emitting Diode (LED) disposed at the button region 90 or a separately provided LED to instruct that the button region 90 is invalid. In the meantime, when a function changes, for example when a moving image playback function is terminated or a mode of the portable terminal is switched from a landscape mode to a portrait mode, the controller 160 may again define the button region 90 as a valid region and accordingly adjust the LED to instruct that a corresponding button region 90 is a valid region.

As described above, the portable terminal 100 according to an exemplary embodiment of the present invention may define at least a partial region of the touch panel 143 as an invalid region according to region setting information and region setting information by functions, and normally process a touch event occurring at a valid region. Accordingly, although a user touches a preset region of a touch panel 143 in using a certain function or a certain mode, the user may normally receive execution of a function according to a required touch operation.

The foregoing mobile terminal 100 may further include various additional modules according to provision forms. That is, when the portable terminal 100 is a communication terminal, it may include constructions that are not described such as a near distance communication module for near distance communication, an interface for exchanging data in a wired communication scheme or a wireless communication scheme of the portable terminal 100, an Internet communication module for communicating with an Internet to perform an Internet function, and a digital broadcasting module for receiving and broadcasting digital broadcasting programs. Since the structural elements can be variously changed according to a convergence trend of a digital device, no elements can be listed. However, the portable terminal 100 may include structural elements equivalent to the foregoing structural elements. Further, the terminal 100 may be substituted by specific constructions in the foregoing arrangements according to the provided form or another structure. This can be easily understood by those skilled in the art.

Further, the portable terminal 100 according to an exemplary embodiment of the present invention may include various types of devices having a touch panel. For example, the portable terminal 100 may include an information communication device and a multimedia device such as a Portable Multimedia Player (PMP), a digital broadcasting player, a Personal Digital Assistant (PDA), a music player (e.g., Moving Picture Experts Group (MPEG)-1 or MPEG-2 Audio Layer III (MP3) player), a portable game terminal, a Smart Phone, a notebook computer, a handheld PC, and the like, as well as various mobile communication terminals corresponding to various communication systems.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A touch control method comprising:
collecting at least one touch event of a touch panel;
determining location information of the at least one collected touch event; and
applying a touch event by disregarding the collected touch event when the location information is an invalid region.

2. The method of claim 1, further comprising:
determining a type of activated user function; and
defining a preset region of the touch panel as an invalid region according to the determined type of activated user function.

3. The method of claim 2, wherein the determining the type of activated user function comprises determining activation of at least one of a memo function, a message making function, an electronic mail making function, a file edit function, and a touch pen based user function.

4. The method of claim 1, wherein the collecting of the at least one touch event comprises determining whether a touch area of a region in which the touch events are collected is equal to or greater than a preset value, and
the method further comprises defining a preset region of a touch panel as the invalid region based on an occurrence point of the location information of the touch event when the touch area of a region is equal to or greater than the preset value.

5. The method of claim 1, wherein the applying of the touch event comprises applying only a touch event of a plurality of touch events occurring at a valid region when the plurality of touch events are collected.

6. The method of claim 5, wherein the applying of the touch event comprises determining whether to apply a touch event based on priority information of the plurality of touch events when the plurality of touch events occur at the valid region.

7. The method of claim 6, wherein the applying of the touch event comprises at least one of:
applying only a touch event occurring at a certain object or a multi-touch event according to priority information of a plurality of objects when a touch event occurs on the objects output on the valid region;
applying only a touch event occurring at a certain frame or a multi-touch event according to priority information of a plurality of frames when a plurality of touch events occur on a page composed of the plurality of frames, each frame consisting of at least one object output on the valid region; and
applying only a touch event occurring at a certain page or a multi-touch event according to priority information of the pages when a touch event occurs on layers, each layer composed of the pages output on the valid region.

8. The method of claim 1, further comprising at least one of:
changing a mode of a portable terminal from a portrait mode to a landscape mode;
defining a button region on which only a touch panel is disposed of the button region as an invalid region and defining an image region on which a display panel and the touch panel are simultaneously disposed as a valid region when the mode of the portable terminal changes to the landscape mode; and
defining the button region, which was defined as the invalid region, as the valid region when the mode of the portable terminal changes from the landscape mode to the portrait mode.

9. The method of claim 8, further comprising at least one of:
instructing that the button region is defined as the invalid region; and
instructing that the button region is defined as the valid region.

10. The method of claim 8, further comprising:
outputting a touch map corresponding to the button region on a preset region of the image region when a preset touch event occurs at the preset region of the image region.

11. A portable terminal for supporting touch control, the portable terminal comprising:
a touch panel for collecting at least one touch event; and
a controller for determining location information of the at least one collected touch event, and for performing a controlling operation so that the collected touch event is disregarded when the location information of the at least one collected touch event is an invalid region.

12. The portable terminal of claim 11, further comprising a memory for storing region setting information by functions defining a preset region of a touch panel as the invalid region according to a type of an activated user function.

13. The portable terminal of claim 12, wherein the region setting information by functions comprises a user function list of at least one of a memo function, a message making function, an electronic mail making function, a file edit function, and a touch pen based user function.

14. The portable terminal of claim 11, wherein the controller determines whether a touch area of a region in which the touch events are collected is equal to or greater than a preset value, and defines a preset region of a touch panel as the invalid region based on an occurrence point of the location information of the touch event when the touch area of a region is equal to or greater than the preset value.

15. The portable terminal of claim 11, wherein the controller performs a controlling operation so that only a touch event of a plurality of touch events occurring at a valid region is applied to a corresponding function when the plurality of touch events are collected from the touch panel.

16. The portable terminal of claim 15, wherein the controller determines whether to apply a touch event based on priority information of the plurality of touch events when the plurality of touch events occur at the valid region.

17. The portable terminal of claim 16, wherein the controller performs a controlling operation so that only a touch event occurring at a certain object or a multi-touch event is applied according to priority information of a plurality of objects when a touch event occurs on the objects output on the valid region;
performs a controlling operation so that only a touch event occurring at a certain frame or a multi-touch event is applied according to priority information of a plurality of frames when a plurality of touch events occur on a page composed of the plurality of frames, each frame consisting of at least one object output on the valid region; and
performs a controlling operation so that only a touch event occurring at a certain page or a multi-touch event is applied according to priority information of the pages when a touch event occurs on layers, each layer composed of the pages output on the valid region.

18. The portable terminal of claim 11, wherein the controller defines a button region on which only a touch panel is disposed of the button region as an invalid region and defining an image region on which a display panel displaying image and the touch panel are simultaneously disposed as a valid region when the mode of the portable terminal changes to the landscape mode when a mode of a portable terminal changes from a portrait mode to a landscape mode; and
defines the button region, which was defined as the invalid region, as the valid region when the mode of the portable terminal changes from the landscape mode to the portrait mode.

19. The portable terminal of claim 18, further comprising a light emitting diode for instructing that the button region is defined as the invalid region or for instructing that the button region is defined as the valid region.

20. The portable terminal of claim 18, wherein the display panel outputs a touch map corresponding to the button region on a preset region of the image region when a preset touch event occurs at the preset region of the image region.
